(19) United States
(12) Patent Application Publication
(10) Pub. No.: US 2009/0274866 A1
(43) Pub. Date: Nov. 5, 2009

(54) CERAMIC ARTICLE AND METHOD FOR MAKING IT

(76) Inventors: Michelle Dawn Fabian, Horseheads, NY (US); Kevin Robert McCarthy, Horseheads, NY (US)

Correspondence Address: CORNING INCORPORATED, SP-TI-3-1, CORNING, NY, 14831, US

(21) Appl. No.: 12/420,121

(22) Filed: Apr. 8, 2009

Related U.S. Application Data
(60) Provisional application No. 61/125,952, filed on Apr. 30, 2008.

(51) Int. Cl. B32B 3/12; B29C 47/00; C08L 85/02; C08L 67/00

(52) U.S. Cl. 428/116; 264/176.1; 524/610; 524/599

(57) ABSTRACT

Extruded ceramic bodies such as extruded honeycomb bodies formed of plasticized ceramic powder pastes made from paste batches comprising one or a combination of ceramic powders together with a water vehicle and a cellulose ether binder, wherein a high-molecular-weight polymeric dispersant is incorporated in the batches to reduce batch mixing torque and extrusion pressure while maintaining the stiffness and mechanical durability of the extrusions.

### CROSS-REFERENCE TO RELATED APPLICATIONS

This application claims the benefit of priority under 35 U.S.C. § 119(e) of U.S. Provisional Application Ser. No. 61/125,952 filed on Apr. 30, 2008.

### BACKGROUND

The compositions, methods, and articles disclosed herein are in the field of ceramic manufacture, and particularly relate to improved processes for the production of ceramic articles of complex configuration by the extrusion of plasticized, highly-filled ceramic pastes.

The manufacture of complex ceramic shapes such as ceramic honeycombs by the extrusion of plasticized mixtures of ceramic powders dispersed in liquid vehicles is well known. One of the largest applications of this technology is for the production of ceramic honeycombs used for the processing of fluid streams, especially for the treatment of exhaust gases from combustion engines to remove pollutants therefrom. Thus ceramic honeycombs composed of materials such as cordierite, silicon carbide and aluminum titanate are in widespread use for the removal of particulates from diesel engine exhausts, and gaseous pollutants such as carbon monoxide, unburned hydrocarbons, and nitrogen oxides from both diesel and gasoline combustion engines.

The art of formulating plasticized mixtures suitable for the production of ceramic honeycombs is complex. Water is the most commonly used liquid vehicle component of such mixtures, and water-soluble cellulose ethers such as methyl cellulose and hydroxypropyl methylcellulose are most frequently used as the binding components in such mixtures. Beyond these, however, the number of components additionally employed to enhance the properties of plasticized mixtures for batch compounding and mixing, extrusion, post-forming shape retention, and stability against cracking during subsequent drying and high-temperature firing of ceramic honeycomb shapes is very large. Examples of some of the more commonly used additives are surfactants and dispersants to promote batch mixing, lubricants such as waxes, fats and oils to facilitate extrusion forming, and various organic and inorganic additives to improve extruded shape retention or resistance to cracking of the extrudates on drying or firing. Organic and/or inorganic additives to control the porosity of the fired ceramics may also be required.

The selection of particular additives to address particular manufacturing problems or finished product requirements is not always straightforward. The behavior of any specific batch mixture during production is found to depend not only on the particular makeup of the ceramic powder blend employed to produce a specific product composition, but also upon the various interactions among the ceramic powders, vehicle components, and additives that may arise in the course of mixing, forming, drying and firing. The use of a particular additive found to be effective to solve one particular production problem can in fact be prohibited if that additive aggravates another production problem, or introduces a new problem through an unfavorable interaction with other mixture components.

Particular examples of problems that persist in this industry are those of high batch mixing loads and high extrusion pressures, particularly in twin screw extruders of the type presently used for the high volume production of ceramic honeycombs for engine emissions control applications. Current honeycomb extrusion die designs place a definite upper limit on useful extrusion pressures, while batch mixing torque and shearing must be limited in order to avoid unacceptable heating of the extrusion batch in the extruders.

Various approaches to solve these problems have been tried. Increases in batch water and/or the addition of oils or other lubricants can reduce mixing shear and decrease extrusion pressures, but at the same time can reduce batch stiffness, producing wet extrudates that exhibit poor shape retention and inadequate resistance to handling deformation. Surfactants and dispersants have been used as vehicle additives or to pre-treat the ceramic powders to improve batch mixing behavior or extrudability. However, the additives so far tested have not been found effective to significantly reduce batch mixing shear and heating. Further, in some cases interactions among these additives or between the additives and other batch constituents such as the cellulosic binders have made the batches less heat-tolerant, by decreasing the temperatures at which gelation of the batch can occur. Further, ceramic powder pre-treatments have not been favored because they add significant cost to the manufacturing process.

Thus there remains a need to provide improved ceramic batch formulations and processing methods that effectively and economically address the problems of excessive batch mixing shear, batch overheating, and high extrusion pressures without adversely impacting wet extrudate mechanical stability, extrudate drying and firing behavior, or other aspects of the production process.

### SUMMARY

The present disclosure encompasses improved batch mixtures and methods for manufacturing extruded ceramic products from such mixtures that secure increased production efficiency without adversely affecting the quality of the resulting products. The disclosed methods can be applied with particular effectiveness to the manufacture of ceramic honeycombs, especially honeycombs based on new ceramic formulations recently developed for advanced engine emissions control applications, such as aluminum titanate honeycombs. Some of these new ceramic formulations have proven especially difficult to process at reasonable extrusion speeds and acceptable selection rates. Those methods are well adapted to address concerns relating to excessive batch mixing shear and extrusion pressures arising with these formulations.

In a first aspect, therefore, the present disclosure comprises improved batch formulations providing plasticized ceramic pastes with enhanced extrusion properties. The plasticized pastes herein disclosed consist of blended mixtures comprising ceramic powder, a cellulose ether binder, water, and a high-molecular-weight polymeric dispersant. The polymeric dispersant selected is of a molecular weight and polymer type that effectively limits batch shearing and thus mixing torque, as well as extrusion pressure, without adversely affecting batch stiffness and the ability of the extruded material to faithfully retain an extruded shape. Thus undried (“wet”) extruded ceramic bodies of complex configuration produced using these polymeric dispersants, such as thin-walled honeycomb extrudates, are fully self supporting and resistant to deformation during subsequent handling prior to drying.

In a further aspect, the present disclosure provides a method for manufacturing ceramic products that employs the above-described batch formulations. More particularly, the disclosure includes methods of manufacturing an extruded ceramic body that include the steps of compounding a batch mixture comprising a ceramic powder component, water, a cellulose ether binder, and a high-molecular-weight polymeric dispersant; thoroughly blending the ceramic powder, water, binder and dispersant to form a plasticized ceramic paste; and pressing the ceramic paste through an extrusion die to form the extruded ceramic body. In selected embodiments of the present disclosure the extrusion die is a honeycomb die and the extruded ceramic body is a wet honeycomb body that retains its extruded shape despite the presence of retained water.

In yet another aspect the present disclosure includes a self-supporting wet extruded ceramic honeycomb body exhibiting good resistance to post-extrusion deformation and handling damage. The extruded body has a composition corresponding to that of the above-described plasticized ceramic pastes, comprising ceramic powders, a cellulose ether binder, water, and a high-molecular-weight polymeric dispersant. The ceramic powders may consist of single-component particulates such as cordierite or silicon carbide, or mixtures of oxides or other compounds that are convertible to crystalline ceramic materials upon firing. The high-molecular-weight polymeric dispersants are, again, polymers of a molecular weight and polymer type that, while effective to limit extrusion pressures, do not adversely affect the ability of the extruded ceramic honeycomb bodies to retain their extruded shapes.

Additional features and advantages of embodiments of the compositions, methods and articles disclosed herein will be set forth in the detailed description which follows, and in part will be readily apparent to those skilled in the art from that description or recognized through the practice of those methods, including the detailed description which follows, the claims, as well as the appended drawings.

It is to be understood that both the foregoing general description and the following detailed descriptions are intended to provide an overview or framework for understanding the nature and character of the disclosed methods, compositions and articles as claimed. The accompanying drawings are included to provide a further understanding of specific embodiments thereof, being incorporated into and constituting a part of this specification and serving to explain selected principles and modes of operation of those embodiments.

### BRIEF DESCRIPTION OF THE DRAWINGS

The disclosed embodiments are hereinafter more fully described with reference to the appended drawings, wherein:

FIG. 1 is a graph relating rheometer mixing torque to mixing time for a group of plasticized ceramic powder paste mixtures;

FIG. 2 is a graph relating rheometer mixing torque to extrudate stiffness for a group of plasticized ceramic powder paste mixtures;

FIG. 3 is a graph relating total deformation stress to extrudate stiffness for a group of plasticized ceramic powder paste mixtures; and

FIG. 4 plots extruder mixing torque versus mixing time for extrusion runs conducted for a group of plasticized ceramic powder paste mixtures.

### DETAILED DESCRIPTION

The compositions and methods disclosed herein are applicable to the production of extruded ceramic bodies over a wide range of ceramic compositions, but as noted above offer particular advantages for the manufacture of ceramics comprising high proportions of alumina (aluminum oxide), titania (titanium dioxide), and/or precursor compounds of aluminum and titanium that yield alumina and titania upon firing. Advanced ceramics of aluminum titanate composition offer substantial advantages over most other ceramics in terms of refractoriness, thermal shock resistance, and high-temperature chemical stability, and are of increasing commercial interest for the manufacture of exhaust emissions control products, especially wall-flow filters for treating diesel engine exhaust gases. Accordingly, the following detailed descriptions and illustrative examples, although presented with particular reference to such compositions, are not intended to be limiting but rather have clear application to a broader range of ceramic materials.

Low molecular weight surfactants and/or dispersants, including additives such as ethylene glycol, dextrin, fatty acid soaps, polyalcohols, and polyimines, have been used in the prior art to modify batch rheology in water-based ceramic paste extrusion systems. However, plasticized powder batches comprising major proportions of titania and alumina or their precursors can exhibit much higher mixing torque, batch shear, and batch heating during mixing than more conventional silicon carbide or magnesium aluminosilicate (e.g., cordierite-forming) batches. Thus the former batches are significantly more difficult to extrude into deformation-resistant honeycombs at sustainable extruder pressures and reasonable extrusion rates.

Unfortunately low molecular weight surfactants and dispersants of the types above described have so far not been found to be effective to reduce mixing shear and extrusion pressures in aluminum titanate batches. In fact, some of these additives have been found to degrade paste extrusion characteristics, particularly in water-based ceramic pastes comprising cellulose ether binders, because they can undesirably interact with other constituents to lower the so-called gel point temperature of the paste, that is, to increase the susceptibility of the pastes to heat gelation and stiffening.

For purposes of the present description we define high-molecular-weight polymeric dispersants as dispersants having average molecular weights in excess of 1000, and preferably of at least 2000 or above. Examples of polymeric dispersant families of the requisite molecular weight, and with the ability to interact favorably with cellulose-thickened water-based alumina-titania powder batch constituents, include anionic phosphated alkoxylated polymers, alkylammonium salts of acidic polyesters, and anionic amine-neutralized polymeric phosphate esters. Favorable interactions include the ability to ameliorate mixing shear without lowering the gel point of the cellulose-thickened water vehicle component of the mixture. Thus selected embodiments of the disclosed dispersants will significantly reduce the mixing torques required to achieve thorough batch mixing, as well as the pressures required to extrude the plasticized pastes into honeycombs or other bodies. Both are achieved without unduly reducing blended batch stiffness, so that the mechanical properties of the wet extrudates are not compromised and significantly increased extrusion rates and production efficiencies are achieved.

Dispersants of the above-specified molecular weights and polymer types have previously found application in the paint industry, where they have been used to promote pigment and/or filler dispersion in liquid paint batches. However, special processing such as bead milling of the dispersants with the pigments is normally required in these highly liquid systems to secure the desired dispersant effects. Absent such pre-treatments, the effectiveness of these and other surfactants or dispersants to improve the rheologies of liquid/particulate-solid mixtures is quite unpredictable, and can only be determined by trial and error.

Unexpectedly, the high-molecular-weight polymeric dispersants disclosed herein interact sufficiently quickly with alumina-titania batch components in conventional processing equipment for the compounding of highly-filled paste mixtures that useful mixing torque and extrusion pressure reductions can be achieved simply by directly incorporating the dispersants along with the other constituents in the powder-water-binder batches. Thus the ceramic powders need not be pretreated with the dispersants, but may be incorporated in as-received condition, i.e., with surfaces free of organic pre-treatment coatings. Somewhat unexpectedly it appears that good dispersant-particle interactions will occur even though the powder filling levels are quite high and the water-based pastes have relatively low water contents (generally less than about 20% by weight of the plasticized mixtures).

The proportions of polymeric dispersant to be incorporated in these water-based ceramic paste batches will vary depending upon the particular ceramic compositions and cellulosic binders selected for use, but the most effective dispersant levels may readily be determined by routine experiment. The minimum additions used should be those at least effective to substantially reduce the mixing torque required to plasticize the ceramic powder-binder-water mixtures. Maximum additions should be below levels that will substantially reduce the stiffness of the plasticized ceramic pastes or decrease the thermal gel point thereof. Stiffness reductions or gel point reductions of more than 10% are considered to be substantial. For most purposes, dispersant concentrations in the range of about 0.02-2% by weight of the plasticized paste will meet these requirements and provide good results.

Selected embodiments of the polymeric dispersants described herein will also exhibit good compatibility with other conventional additives, including those that are optionally but commonly used in powdered ceramic extrusion mixtures. For example, the disclosed plasticized ceramic paste batches may comprise, in addition to the above-described essential constituents, various optional additives including lubricants such as oils, waxes and polymers for improved extrudability and extruded shape retention, and pore-forming additives such as graphite, starch or other fugitive organics used to control the porosities of the fired ceramic end products.

As previously noted, while the embodiments set out in this disclosure have application to the processing of a wide range of ceramic compositions, it may be adapted with special effectiveness to the processing of alumina-titania batches formulated for the production of aluminum titanate ceramic honeycombs. These batches will typically comprise a ceramic powder component wherein compounds selected from the group of aluminum oxide, titanium dioxide, and precursor compounds thereof will constitute at least 60% by weight of the ceramic powders. Examples of precursor compounds of alumina that may be used include aluminum hydroxide and any of the various hydrous aluminas. Such powder mixtures have proven particularly difficult to process at reasonable mixing torques and extrusion pressures using conventional water-cellulose vehicle systems.

The cellulose ether binder components present in the plasticized pastes of the disclosed compositions may include any of the cellulose derivatives or mixtures thereof found useful for the production of water-based plasticized ceramic powder batches. Examples include hydroxypropyl methylcellulose, methyl cellulose, hydroxyethyl cellulose, carboxylmethyl cellulose, and related cellulosic compounds. The proportions of cellulosic binders in the plasticized mixtures are conventional, typically in the range of 1-8% by weight.

The improvements in extrusion batch rheology resulting from the use of polymeric dispersants in accordance with the present disclosure are particularly valuable in continuous extrusion processes for the production of ceramic honeycombs. As noted above, such processes are typically carried out using large twin-screw extruders that continuously convert a loose powder-water-binder input feed into a fully blended and plasticized ceramic paste, and simultaneously press the blended paste through a honeycomb extrusion die at the output end of the extruder. Adapting such processes to the production of alumina-titania ceramics has been complicated by high batch mixing torques and high extrusion pressures when conventional water-cellulose vehicles are used. The resulting high shearing generates increased extruder temperatures which, at commercially acceptable production rates, can exceed the gel point of the vehicles.

The batch rheology improvements secured through the use of the disclosed materials, on the other hand, significantly decrease extruder torque and thereby reduce heat buildup in the extruders. This enables faster feed and extrusion rates, yet requires no change to existing batching or extrusion processes, beyond simply including the polymeric dispersants in the batch mixtures during the initial compounding of the batch. Further, in contrast to the results observed with certain prior art surfactant additives, no objectionable reductions in batch gel temperature are observed.

The methods, compositions and articles encompassed within the present disclosure are are further described below with reference to the following detailed examples, which are intended to be illustrative rather than limiting.

### Examples

### 1. Paste Mixing and Rheology Testing

A number of ceramic powder batches suitable for the extrusion of ceramic bodies such as ceramic honeycombs are compounded from a blend of ceramic powders, methyl cellulose binders, water, and an optional pore former for fired ceramic porosity control. Selected ones of the batches include a high-molecular weight polymeric dispersant to improve batch mixing behavior. Table 1 below sets forth approximate compositions for such batches, exclusive of batch water (vehicle), wherein the proportions of all constituents are set out in parts by weight. All of the dry ingredients, including the inorganic oxides and salts as well as the graphite, starch, and cellulose binder, are weighed as fine powders.

TABLE 1
Plasticized Ceramic Paste Compositions

| | Example ID | | | | | |
|---|---|---|---|---|---|---|
| Material | Control | 1 | 2 | 3 | 4 | 5 |
| Al₂O₃ | 46.57 | 46.57 | 46.57 | 46.57 | 46.57 | 46.57 |
| TiO₂ | 29.95 | 29.95 | 29.95 | 29.95 | 29.95 | 29.95 |
| SiO₂ | 10.19 | 10.19 | 10.19 | 10.19 | 10.19 | 10.19 |
| SrCO₃ | 8.00 | 8.00 | 8.00 | 8.00 | 8.00 | 8.00 |
| Al(OH)₃ | 3.71 | 3.71 | 3.71 | 3.71 | 3.71 | 3.71 |
| CaCO₃ | 1.38 | 1.38 | 1.38 | 1.38 | 1.38 | 1.38 |
| La₂O₃ | 0.20 | 0.20 | 0.20 | 0.20 | 0.20 | 0.20 |
| Graphite | 10.00 | 10.00 | 10.00 | 10.00 | 10.00 | 10.00 |
| Starch | 8.00 | 8.00 | 8.00 | 8.00 | 8.00 | 8.00 |
| Methylcellulose | 4.50 | 4.50 | 4.50 | 4.50 | 4.50 | 4.50 |
| Oil | 1.0 | 1.0 | 0 | 1.0 | 1.0 | 0 |
| Dispersant 1* | 0 | 0.1 | 1.0 | 0 | 0 | 0 |
| Dispersant 2* | 0 | 0 | 0 | 0.25 | 0 | 0 |
| Dispersant 3* | 0 | 0 | 0 | 0 | 0.05 | 0.5 |

*Dispersant 1 = Solsperse 40000 - proprietary commercial anionic phosphated alkoxylated polymer; Noveon Inc., Cleveland, OH, USA; approx. m.w. 3600
*Dispersant 2 = Disperbyk 180 - proprietary commercial alkylammonium salt of acidic polyester; Byk-USA; Wallingford, CT, USA; est. m.w. > 1000
*Dispersant 3 = Borchi Gen BG650 - proprietary commercial anionic amine-neutralized polymeric phosphate ester; Lanxess Corporation, Pittsburgh, PA, USA; approx. m.w. 96000

To prepare plasticized extrusion batches from the compositions set out in Table 1, the ceramic powders, pore formers, and cellulose binder are dry-blended in a Littleford mixer, while the vehicle components including any optional oil, the polymeric dispersants, and sufficient water to achieve batch plasticity are separately blended in a high speed mixer. The powders and mixed liquids are then combined and hand-mixed for 5 minutes to uniformly wet the powders, following which each of the resulting mixtures is then charged into a Brabender torque rheometer and mixed for 20 minutes at 50 rpm to develop fully plastic ceramic paste mixtures while charting the mixing torque required to work the mixtures into plastic masses. The water additions used to plasticize these mixtures are set to yield water concentrations of 15%, 16% and 17% by weight in the fully plasticized wet batches.

The pastes thus provided are next compacted for extrusion, with portions of each batch being separately charged into a capillary rheometer tube, de-aired, and compacted at 1000 kgF. The compacted pastes are then extruded into ribbon and rod samples for squeeze flow rheology testing and gel point measurements.

Gel point testing is carried out by measuring the stiffness of the plasticized pastes as the pastes are heated over a range of temperatures extending from below to above the gel point. Rheology testing is by conventional squeeze flow rheometry, involving the tracking of the deformation force arising during the constant velocity piston compression of 4 mm thick ribbon samples against a flat, fixed base plate by a cylindrical piston of 0.5 inches diameter. Representative data from rheology tests conducted for the Control sample and paste Examples 1 and 2 from Table 1 as described above are reported in Table 2 below. Data are provided for each of those compositions at paste water levels of 15%, 16% and 17% by weight.

Among the data reported in Table 2 are peak and end paste mixing torques (in meter-grams) as recorded by the Brabender rheometer, the deformation stiffness (E₀) of the extruded ribbon samples as determined during the initial or compaction stage of squeeze flow testing, and the total deformation stress (P) of the ribbons as measured over the second or deformation stage of the squeeze flow test. The E₀ values correspond essentially to the maximum resistance of the ribbon samples to initial compaction, i.e., the maximum initial slope of the piston force-piston displacement curve (in Newtons per mm). The total deformation stress P (in kPa) is a measure of the piston pressure required to maintain axial and lateral paste flow as the piston-plate gap narrows and lateral paste flow becomes significant. As is conventional, the P values reported in Table 2 are calculated from the piston force recorded at the point where the ratio of cylindrical piston radius R to remaining sample thickness h is 10.

TABLE 2
Torque and Squeeze Flow Rheometry Results

| | | Peak | End | | |
|---|---|---|---|---|---|
| | % | Torque | Torque | | P@R/h = 10 |
| Example ID | Water | (m-g) | (m-g) | E₀ (N/mm) | (kPa) |
| Control | 15 | 5370 | 2650 | 128 +/− 11 | 1060 +/− 20 |
| Control | 16 | 4560 | 2240 | 102 +/− 7 | 752 +/− 25 |
| Control | 17 | 4430 | 2310 | 65 +/− 12 | 699 +/− 53 |
| Ex. 1 | 15 | 4170 | 2730 | 124 +/− 5 | 760 +/− 29 |
| Ex. 1 | 16 | 3670 | 2590 | 89 +/− 13 | 662 +/− 43 |
| Ex. 1 | 17 | 3390 | 2270 | 45 +/− 2 | 461 +/− 14 |
| Ex. 2 | 15 | 4050 | 2240 | 143 +/− 3 | 822 +/− 26 |
| Ex. 2 | 16 | 3700 | 2100 | 95 +/− 5 | 669 +/− 2 |
| Ex. 2 | 17 | 3310 | 2080 | 61 +/− 4 | 573 +/− 12 |
| Ex. 3 | 16 | 3470 | 2190 | 46 +/− 5 | 485 +/− 11 |
| Ex. 4 | 15 | 3530 | 2280 | 78 +/− 5 | 545 +/− 17 |
| Ex. 4 | 16 | 3230 | 2000 | 60 +/− 3 | 448 +/− 22 |
| Ex. 4 | 17 | 2960 | 2020 | 38 +/− 4 | 355 +/− 13 |
| Ex. 5 | 16 | 4020 | 2170 | 55 +/− 2 | 549 +/− 28 |

As the Table 2 data confirm, significant reductions in peak mixing torque at equivalent water loadings are achieved in the paste Examples comprising a high-molecular-weight polymeric dispersant when compared with dispersant-free Control samples. These reductions indicate a significant lowering of the amount of heat generated by batch shearing during mixing of these paste batches at each of the three batch water levels tested.

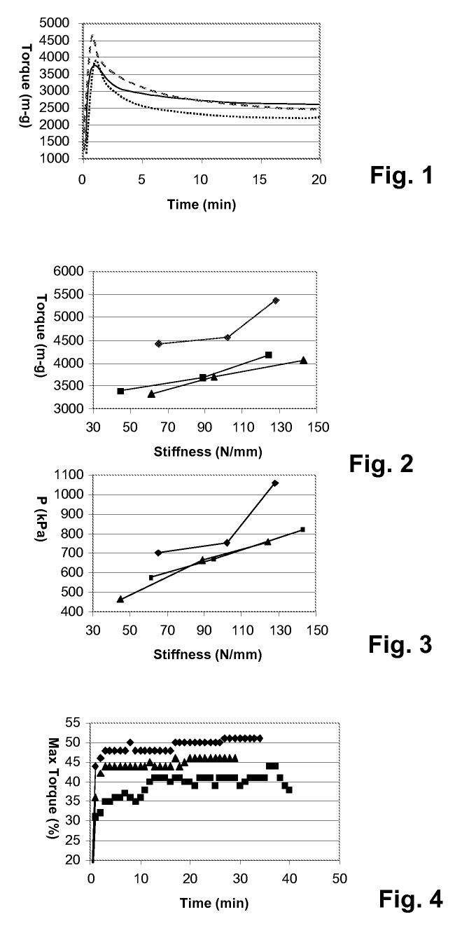

FIG. 1 of the drawings includes representative Brabender torque curves for each of the Control (dashed line) and Examples 1 and 2 (solid and dotted lines, responsibility) from Table 1 at the 16% batch water level. The time-torque curves illustrate the typical manner in which mixing torques in these powder-water mixtures rise rapidly to peak values during the initial mixing stage, and then gradually decease to lower end values as plasticization of the paste mixtures is completed.

FIG. 2 of the drawings illustrates the relationship between peak mixing torque and average stiffness for the Control examples (diamond) and for Examples 1 and 2 (square and triangle, respectively) from Table 2 at all three batch water levels, those examples incorporate two different levels of a particular phosphated alkoxylated polymeric dispersant, in one case with an optional oil addition and in one case without. The FIG. 2 plot of Peak Torque versus Stiffness E₀ reflects the fact that, at equivalent paste stiffness levels, the particular dispersant-modified compositions exhibit significantly lower peak torque at all three batch water levels. Thus while extrudates formed from these dispersant-modified compositions will exhibit good resistance to sag and deformation, i.e., resistance substantially equivalent to the Control compositions at equivalent water levels, considerably less shear energy is required to plasticize the dispersant-modified pastes.

FIG. 3 of the drawings illustrates the relationship between average stiffness and total deformation stress for the Control (diamond) and Examples 1 and 2 (square and triangles, respectively) from Table 2 above at each of the three water levels reported. The plot of total deformation stress P versus Stiffness E₀ in FIG. 3 illustrates the improved pressure-stiffness balance achievable in plasticized pastes comprising one embodiment of the high-molecular-weight polymeric dispersant additives disclosed herein. More particularly, at equivalent batch stiffness (indicating equivalent deformation resistance), and especially at lower water levels, the addition of the dispersant substantially decreases the total deformation stresses exhibited by the pastes. The total deformation stresses determined by squeeze flow testing are generally proportional to the peak extrusion pressures that will be developed in extruders as the dispersant-modified pastes are pressed through extrusion dies during honeycomb manufacture.

Batch gelation temperature testing is carried out on the plasticized paste batches by monitoring the entry pressure required to force the pastes through a capillary tube as the temperature of the material is gradually raised from ambient to approximately 60 degrees C. The onset of batch gelation is that temperature at which a rapid rise in entry pressure is observed. Data from the testing of the Control paste and the pastes of composition Examples 1 and 2 from Table 1 by this method establish that no observable reductions in paste gel temperatures result from the inclusion of the high-molecular-weight polymeric dispersants in these pastes.

### 2. Honeycomb Extrusion

Honeycomb extrusions carried out using a small twin screw extruder further illustrate the improvements in ceramic paste properties that may be secured through the use of high-molecular-weight polymeric dispersants in accordance with the present disclosure. To carry out these extrusions, dry batches of the Control composition and composition Examples 1 and 2 from Table 1 above are charged to a Littleford mixer and dry-blended for 5 minutes. Dry mixing is followed by a one-minute water injection, a one-minute oil injection (where an oil component is present), and in the case of Examples 1 and 2, a one-minute dispersant addition. Water additions providing batches of both 15% and 16% water by weight are used.

After a further one-minute blending period, the wet batches are loaded into a mechanical feeder for continuous delivery to the input of the extruder. Following blending and plasticization of the batch feed within the extruder, the plasticized pastes are pressed through a honeycomb extrusion die at the extruder outlet to form wet cylindrical honeycomb extrudates. The wet honeycombs have channel walls of 0.014 inches thickness and a cell density of 300 honeycomb channels per square inch of honeycomb cross-section.

Measurements of extruder torque, maximum extruder pressure, and paste pressure on the inlet face of the honeycomb extrusion die are made during the blending, plasticization, and extrusion of the sample batches. The extruded honeycombs are also tested for deformation resistance by ball penetrometer testing to evaluate extrudate stiffness.

FIG. 4 of the drawings contains plots of measured extruder torque versus run time as the above-described batch mixtures corresponding to the Control composition (diamond) and composition Examples 1 and 2 (square and triangle, respectively) from Table 1 are transported into and through extruder. All sample batches tracked in FIG. 4 contain 15% water by weight. The torque values in FIG. 4 are reported as percentage values representing the fraction of the extruder maximum torque limit required to maintain a constant screw rotation rate for each of the batches.

As is evident from the torque-run time plots presented in FIG. 4, plasticization of the dispersant-modified ceramic pastes corresponding to the Example 1 and Example 2 compositions is achieved at significantly lower peak extruder torques than are required to process the Control composition. Accordingly, the level of extruder barrel cooling required to maintain batch temperatures well below the batch gel point during continuous and sustained extruder operation is reduced.

Table 3 below sets forth extruder pressure, die pressure, and extrudate penetrometer data collected during the extruder runsg described above. Included in Table 3 for each of the runs conducted are an identification of the batch composition from Table 1, the water content of the batch, the average maximum paste pressure (Pmax) within the extruder during each run, and the average pressure exerted on the extrusion die (P-die) during paste extrusion. Also included is relative extrudate stiffness, reported as pounds of force required to be applied by a ball probe to the exterior skins of the extruded honeycomb shapes that will cause deformation of the extruded shapes.

TABLE 3
Extruder Run Data

| | | | | Extrudate |
|---|---|---|---|---|
| Batch ID | % Water | Pmax (psi) | P-Die (psi) | Stiffness (lbs) |
| Control | 15 | 2689 | 1485 | 2.6 |
| Ex. 1 | 15 | 2355 | 1155 | 2.6 |
| Ex. 2 | 15 | 2276 | 1299 | 2.5 |
| Control | 16 | 2031 | 1089 | 1.88 |
| Ex. 1 | 16 | 1768 | 738 | 2 |
| Ex. 2 | 16 | 1513 | 826 | 1.96 |

The Table 3 data clearly evidence the fact that the addition of a high-molecular-weight polymeric dispersant to the described ceramic paste batches results in significant reductions in both maximum extruder pressure and force on the extrusion die during the twin screw extrusion of ceramic honeycombs. Further, these reductions are secured without any reductions in extrudate stiffness, insuring that the resistance of the wet extruded ware to handling deformation is not compromised.

A direct consequence of the improvements in paste mixing and extrusion behavior provided through the use of the disclosed dispersants as above described is a substantial improvement in honeycomb manufacturing efficiency. In one case a 10% decrease in extruder mixing torque was found to secure a 10% increase in batch feed rate and extruder output from a large twin screw extruder, all other manufacturing variables remaining the same.

Of course, as indicated above, the foregoing description and examples are merely illustrative of compositions, processes and products that may be provided in accordance with the foregoing disclosure and within the scope of the appended claims.

We claim:

1. A method for manufacturing an extruded ceramic body including the steps of:
compounding a batch mixture comprising a ceramic powder component, water, a cellulose ether binder, and a high-molecular-weight polymeric dispersant;
blending the ceramic powder, water, binder and dispersant to form a plasticized ceramic paste; and
pressing the plasticized ceramic paste through an extrusion die to form a self-supporting wet extruded ceramic body.

2. A method in accordance with claim 1 wherein the ceramic powder component of the batch mixture comprises compounds selected from the group of aluminum oxide, titanium dioxide, and precursor compounds thereof in a combined proportion making up at least 60% by weight of the ceramic powder component, and wherein the water component comprises less than 20% by weight of the batch mixture.

3. A method in accordance with claim 1 wherein the surfaces of the aluminum oxide and titanium dioxide ceramic powders added to the batch mixture are substantially free of organic pre-treatment coatings.

4. A method in accordance with claim 1 wherein the high-molecular-weight dispersant has an average molecular weight in excess of 1000.

5. A method in accordance with claim 4 wherein the high-molecular-weight dispersant is present in the batch mixture in a proportion at least effective to reduce the mixing torque for forming the plasticized ceramic paste.

6. A method in accordance with claim 4 wherein the high-molecular weight dispersant is present in the batch mixture in a proportion below a concentration that substantially reduces the stiffness of the plasticized ceramic paste.

7. A method in accordance with claim 4 wherein the high-molecular weight dispersant is present in the batch mixture in a proportion below a concentration that substantially decreases the thermal gel point of the cellulose ether binder.

8. A method in accordance with claim 4 wherein the high-molecular-weight dispersant is selected from the group consisting of anionic phosphated alkoxylated polymers, alkylammonium salts of acidic polyesters, and anionic amine-neutralized polymeric phosphate esters.

9. A plasticized ceramic paste comprising a blended mixture of:
a ceramic powder component;
a high-molecular weight polymeric dispersant;
a cellulose ether binder, and
water.

10. A plasticized ceramic paste in accordance with claim 9 having a squeeze flow stiffness of at least 40 N/mm and a squeeze flow compressive stress not exceeding 900 kPa under compression by a piston of 0.5 inches diameter.

11. A ceramic paste in accordance with claim 9 having a water content not exceeding 20% by weight, and wherein the ceramic powder component of the paste comprises at least 60% total by weight of compounds selected from the group of aluminum oxide, titanium dioxide, and precursor compounds thereof.

12. A ceramic paste in accordance with claim 11 wherein the high-molecular-weight dispersant has an average molecular weight in excess of 1000 and is present in a proportion of about 0.05-2% by weight of the paste.

13. A ceramic paste in accordance with claim 12 wherein the high-molecular-weight dispersant is selected from the group consisting of anionic phosphated alkoxylated polymers, alkylammonium salts of acidic polyesters, and anionic amine-neutralized polymeric phosphate esters.

14. A ceramic paste in accordance with claim 9 wherein the cellulose ether binder is selected from the group consisting of methyl cellulose and hydroxypropyl methylcellulose.

15. A self-supporting extruded ceramic honeycomb body having a composition comprising ceramic powders, a high-molecular-weight polymeric dispersant, a cellulose ether binder, and water.

16. An extruded honeycomb body in accordance with claim 15 having a water content of at least 15% by weight and a ceramic powder component comprising at least 60% total by weight of compounds selected from the group of aluminum oxide, titanium dioxide, and precursor compounds thereof.
